(19) United States
(12) Patent Application Publication
(10) Pub. No.: US 2005/0288965 A1
(43) Pub. Date: Dec. 29, 2005

(54) Role-based approach for managing patient care information generated by healthcare provider

(75) Inventors: Erik G. Van Eaton, Seattle, WA (US); William B. Lober, Seattle, WA (US); Karen Dombek Horvath, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: University of Washington, Seattle, WA (US)

(21) Appl. No.: 11/166,434

(22) Filed: Jun. 23, 2005

Related U.S. Application Data
(60) Provisional application No. 60/582,434, filed on Jun. 23, 2004.

(51) Int. Cl. G06Q 10/00

(52) U.S. Cl. 705/2

(57) ABSTRACT

A role-based approach is provided for managing patient care information generated by healthcare providers. A team is comprised of multiple healthcare providers, each of whom has primary responsibility, i.e., a role, for a list of patients. The team is also responsible for a specific list of patients. Patients associated with both a team and with a role in the team are identified. Patient care information, including non-medical record comments, for any of such patients can be updated by any healthcare provider fitting the role in the team. Reports can be generated concerning such patients.

### CROSS-REFERENCE TO RELATED APPLICATION

This application claims the benefit of U.S. Provisional Patent Application No. 60/582,434, filed Jun. 23, 2004, entitled Method and System for Managing Healthcare Provider Rounding and Sign-Out Information, the disclosure of which is hereby expressly incorporated by reference, and the filing date of which is hereby claimed under 35 U.S.C. § 119(e).

### FIELD OF THE INVENTION

The present invention relates generally to computer-implemented methods and systems for managing healthcare information, and more particularly to computer-implemented methods and systems for managing patient care information generated by healthcare providers.

### BACKGROUND OF THE INVENTION

The challenge of safe and efficient transfer of patient care from one single healthcare provider or a team of healthcare providers to another in an inpatient or outpatient care setting, such as a hospital or clinic, has increased over the years as new and complex diagnostic tools and more complex treatment options have become available. Traditionally, healthcare providers have ensured continuity of care by working long hours and minimizing the transfer of significant diagnostic or therapeutic responsibilities to other healthcare providers. The traditional approach of healthcare management dictates the traditional way of managing patient care information. FIG. 1 illustrates a traditional patient care information management approach 100, wherein a patient 102 has a one-to-one relationship with an individual healthcare provider 104. The individual healthcare provider 104 may be or may not be part of a team 106 of healthcare providers fulfilling different roles of healthcare responsibilities for the patient. Any non-medical record comments 108 provided by the individual healthcare provider 104 or the team 106, such as summarization or speculation regarding documented patient findings, are associated with the patient 102, and not with the healthcare team 106 for whom the comments are intended.

However, efforts to reduce the long working hours of healthcare providers have curtailed such a traditional way of managing patient care information. Instead of concentrating patient care responsibilities with a minimum number of healthcare providers, multiple healthcare providers may share patient care responsibilities according to their work schedule. Thus, greater emphasis is now placed on increasing workflow efficiency in both capturing and managing patient care information relating to daily patient care work (“rounding”) and in capturing and managing patient information needed for an efficient transfer of care (“sign-out”). Accordingly, because of the increased frequency in transferring a patient among different healthcare providers, the traditional way of patient care information management that is implemented based on the one patient and one individual healthcare provider relationship mapping is no longer desirable. What is needed is a patient care information management system adapted to the new practice wherein multiple healthcare providers may fulfill a healthcare role for a patient, and the patient relationship is mapped to the role rather than to an individual healthcare provider.

In addition, traditionally, healthcare providers have used a paper patient list to manage both nightly sign-out information and daily rounding information. These lists are often maintained by hand or with the use of a computer spreadsheet program. Manually inputted data to the spreadsheet is typically limited to a few reproducible categories (e.g., medications, problem lists, plans, etc.). Daily rounding information (e.g., vital signs, laboratory results) from the patient's medical record is then hand-copied onto a printed copy of the spreadsheet, together with ad-hoc healthcare provider comments that are not found in the patient's medical record but are instead comments by providers intended to summarize and give context to information found in the medical record. However, such a process results in a number of flaws and inefficiencies, including difficulty in accessing spreadsheets, time wasted and errors introduced when data is manually copied, inability to add patients to the patient lists of other healthcare providers, and inability to store and share the non-medical record comments among teams of healthcare providers. Accordingly, what is needed is a computer-implemented method and system for capturing and managing patient care information such as rounding and sign-out information generated by healthcare providers.

### SUMMARY OF THE INVENTION

The invention addresses the above-identified needs by providing a role-based approach for managing patient care information generated by healthcare providers. A list of patients (“team list”) is assigned to a team comprising multiple healthcare providers, each of whom fulfills a healthcare responsibility, i.e. a role, of the team. Each role is also associated with a list of patients (“role list”). The team list and the role list may not be the same. Preferably, any non-medical record comments provided by a member of a team for a patient in the team list of the team is associated with the team, hence is immediately viewable by all members of the team.

One aspect of the invention first identifies the team list associated with a team upon receiving information specifying the team. Such information includes the institution in which the team exists, the healthcare service provided by the team, the name of the team, etc. Upon identifying the team list associated with the team, the invention further identifies patients (“patient list”) in the team list that are associated with a role in the team, upon receiving information specifying the role in the team. Information specifying a role in the team may include “sub-team” name, or team role name or acuity level. For example, consider a surgical team composed of a supervising surgeon, a Trainee A responsible for a particular patient care area, a Trainee B responsible for pre-operative patients and a critical care surgeon responsible for Intensive Care Unit (ICU) patients. The surgical team may be named as “General Surgery Team Blue,” with a list of patients cared for by the entire team, for whom the supervising surgeon is responsible. Those patients may be further subdivided into a list for the sub-team named “East Wing” that would include only the team's patients in that area of the hospital; a role-list called “Trainee B” containing patients associated with Trainee B's role as caring for pre-operative patients; and a list with acuity level “ICU” that contains the subset of patients assigned to the critical care surgeon regardless of the location of those patients. Another aspect of the invention allows a user to add one or more patients to the patient list. Such a patient can be an inpatient or an outpatient. A user may manually enter data for such a patient. After adding the patient to the patient list, the added patient is mapped with the team and the role associated with the patient list.

In accordance with yet another aspect of the invention, data concerning a patient in a patient list associated with a role in a team may be updated by a healthcare provider fulfilling the role in the team. The healthcare provider may update subjective and objective patient care information such as patient demographic information, lab results, history and physical examination findings, etc. The healthcare provider may also provide non-medical record comments about that information based on the healthcare provider's observation and clinical judgment.

In accordance with a further aspect of the invention, patient care information generated by a healthcare provider for a patient may be combined with additional patient information retrieved from an external source such as an enterprise clinical data system and formatted to generate healthcare provider-centered reports.

In accordance with yet a further aspect of the invention, a distributed computing system is provided that includes a server and one or more client devices. The server may be associated with a server database that stores patient care information generated by any healthcare provider fulfilling a role in a team caring for a patient. The server contains a role-based patient care information management program performing aspects of the invention described above. Any of the client devices may remotely operate the program to input, modify, and retrieve patient care information maintained by the server. The program may also provide a user interface through which a healthcare provider may input, modify, and retrieve patient care information. The server database may include a first database storing patient care information generated by a healthcare provider fulfilling a role in the team caring for a patient, and a second database caching patient information imported from an external source.

In summary, aspects of the invention provide a role-based approach for managing patient care information generated by multiple healthcare providers fulfilling a role in a team providing healthcare service. In such a way, multiple healthcare providers can easily share patient care responsibilities according to their work schedule. Patient care information such as obtained or generated during healthcare provider rounding and sign-out is organized according to each team providing care for the patient and may be easily and efficiently transferred among different healthcare providers fulfilling the same role in a team providing healthcare services for the patient.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a block diagram illustrating a traditional approach for managing healthcare information for a patient;

FIG. 2 is a block diagram illustrating aspects of the invention, wherein a role-based approach for managing patient care information generated by a healthcare provider for a patient is provided;

FIG. 3 is a pictorial diagram illustrating a distributed computing system for role-based management of patient care information generated by healthcare providers (the “CORES system”) formed in accordance with one embodiment of the invention;

FIG. 4 is a block diagram illustrating an exemplary application server shown in FIG. 3 that stores and implements a computerized program (the “CORES program”) for role-based management of patient care information generated by healthcare providers formed in accordance with one embodiment of the invention;

FIG. 5 is a schematic overview of the general operation of various components of the CORES program in one embodiment of the invention;

FIG. 6 is a flow diagram illustrating an exemplary process for role-based management of patient care information generated by healthcare providers;

FIGS. 7A-7B are a flow diagram illustrating an exemplary routine for building a patient list, suitable for use in FIG. 6;

FIG. 8 is a flow diagram illustrating an exemplary routine for adding a patient to a patient list, suitable for use in FIG. 7A;

FIG. 9 is a flow diagram illustrating an exemplary routine for updating a patient profile, suitable for use in FIG. 6;

FIG. 10 is a flow diagram illustrating an exemplary routine for producing a report for patient care information generated by the CORES program, suitable for use in FIG. 6;

FIG. 11 is a pictorial diagram illustrating a browser program with an exemplary Web page presenting a user interface for a user to input information for building a patient list;

FIG. 12 is a pictorial diagram illustrating a browser program with an exemplary Web page presenting a user interface for a user to input information for adding one or more patients to a patient list;

FIG. 13 is a pictorial diagram illustrating a browser program with an exemplary Web page presenting a user interface for a user to input data for updating a patient profile; and

FIG. 14 is a pictorial diagram illustrating a browser program with an exemplary Web page presenting a user interface for a user to input information for selecting report format.

### DETAILED DESCRIPTION OF THE PREFERRED EMBODIMENT

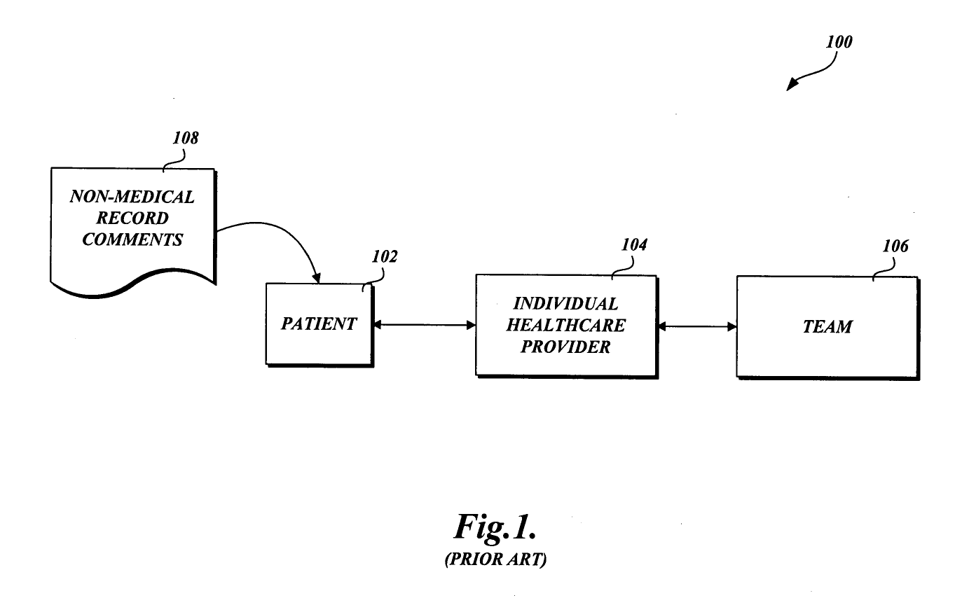

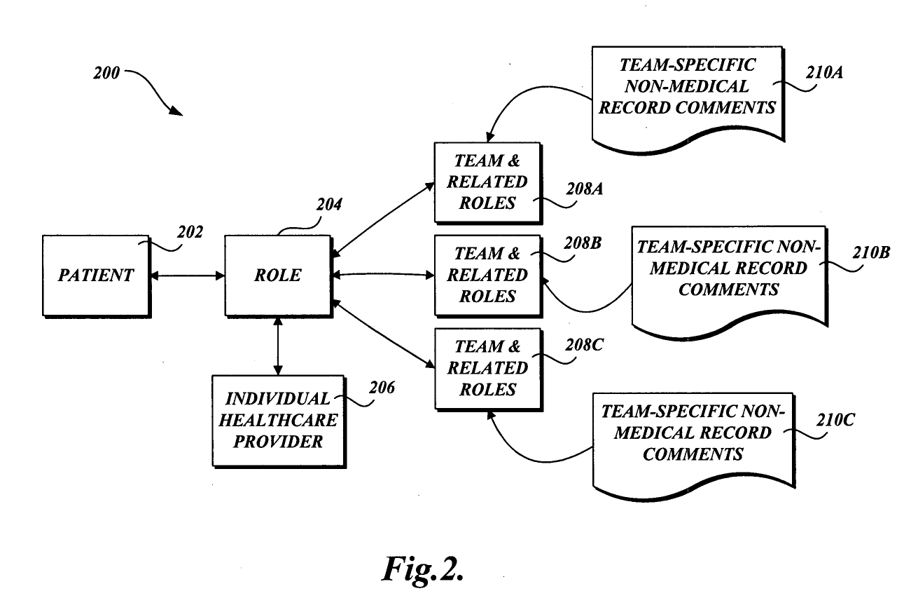

To facilitate the practice of having multiple healthcare providers to fulfill patient care responsibilities for an individual patient, embodiments of the invention provide a role-based approach for managing patient care information generated by healthcare providers, such as healthcare provider rounding and sign-out information. FIG. 2 illustrates aspects of a role-based approach 200. A patient 202 is mapped with at least one role 204, which fulfills a specific patient care responsibility. A role can be, for example, a surgeon, a primary care intern, or a primary resident physician, etc. In a traditional patient care information management approach such as the approach 100 illustrated in FIG. 1, a patient is mapped with one or more healthcare providers. An individual healthcare provider might fulfill a role; but the role is not relevant to the one-to-one patient and healthcare provider relationship. Healthcare information for a patient is maintained based on one-to-one relationship between the patient and the healthcare provider, not based on the role. In contrast, in the role-based approach 200, the role 204 might be fulfilled by an identified individual healthcare provider 206; but the identified individual healthcare provider 206 is not relevant to the relationship between the patient 202 and the role 204. Healthcare information for a patient is maintain based on the patient's relationship with a specific team and a role, not based on the patient's relationship with an individual healthcare provider. As a matter of fact, in embodiments of the invention, each role 204 may be fulfilled, at a different time, by a different healthcare provider in a team, such as team 208A, team 208B, and team 208C. Each team is an organizational unit comprising different roles fulfilled by healthcare providers.

Some embodiments of the invention also associate team-specific non-medical record comments concerning a patient with the team providing care for the patient, instead of with the patient, as the traditional approach such as the approach 100 illustrated in FIG. 1 would have done. As illustrated in FIG. 2, team-specific non-medical record comments 210A are associated with team 208A, team-specific non-medical record comments 210B are associated with team 208B, and team-specific non-medical record comments 210C are associated with team 208C.

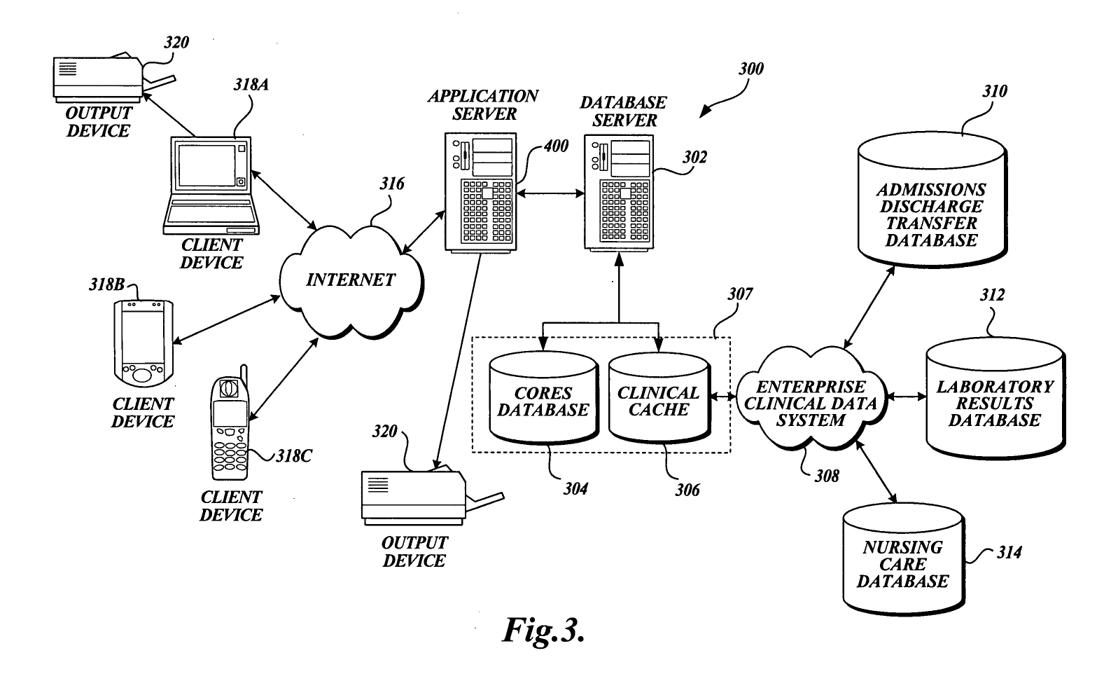

In an exemplary embodiment of the invention, patient care information includes rounding and sign-out information generated by a healthcare provider. Rounding and sign-out information may include, but is not limited to, subjective and objective patient care information, e.g., patient demographic information, lab results, nursing care information, physical examination findings, medication lists, etc. Rounding and sign-out information may also include, but is not limited to, non-medical record comments based on healthcare provider observation and clinical judgments, e.g., notes, possible diagnoses, narratives, concerns, “to do” lists, etc. In embodiments of the invention, once generated and captured, the healthcare provider generated objective and subjective information and the non-medical record comments are combined with additional patient information retrieved from another source, such as an enterprise clinical data system 308 (FIG. 3), and formatted by aspects of the invention to generate healthcare provider-centered reports (as opposed to patient-centered reports), as will be described in more detail below.

In the following paragraphs, various aspects and embodiments of the method, apparatus and system will be described. Specific details will be set forth in order to provide an understanding of the described embodiments of the present invention. However, it will be apparent to those skilled in the art that the described embodiments may be practiced with only some or all of the described aspects, and with or without some of the specific details. In some instances, descriptions of well-known features may be omitted or simplified so as not to obscure the various aspects and embodiments of the present invention.

Parts of the description will be presented using terminology commonly employed by those skilled in the art to convey the substance of their work to others skilled in the art, including terms of operations performed by or components included in the information management system. As well understood by those skilled in the art, the operations typically involve examining, storing, transferring, combining, and otherwise manipulating healthcare information associated with patient care. The term “system” includes general purpose as well as special purpose arrangements of these components that are stand-alone, adjunct or embedded.

Various operations will be described as multiple discrete steps performed in turn in a manner that is most helpful in understanding the present invention. However, the order of description should not be construed to as imply that these operations are necessarily performed in the order they are presented, or even order dependent.

Referenced throughout this specification to “one embodiment” or “an embodiment” means that a particular feature, structure, or characteristic described in connection with the embodiment is included in at least one embodiment of the present invention. Thus, appearances of the phrase “in one embodiment” or “in an embodiment” in various places throughout the specification are not necessarily all referring to the same embodiment.

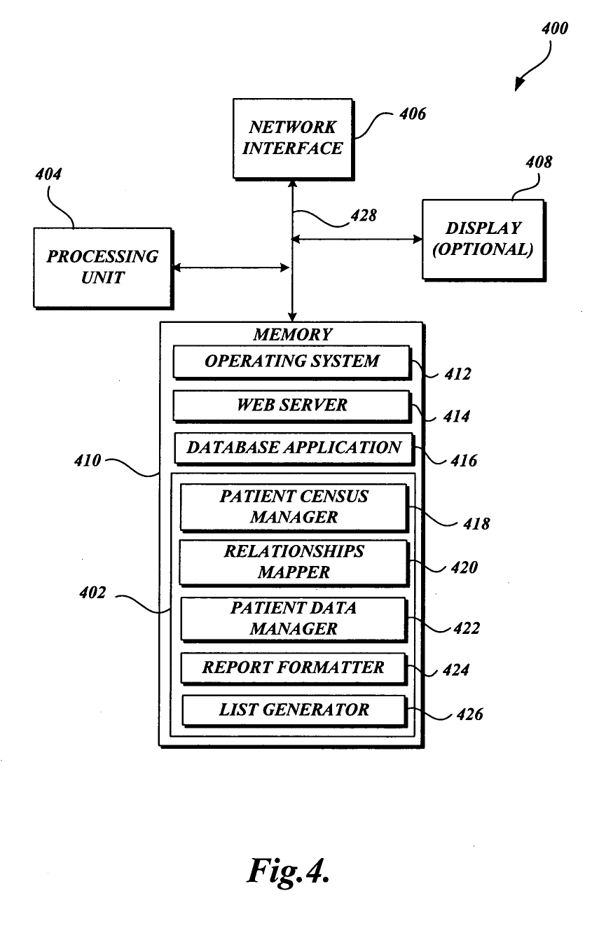

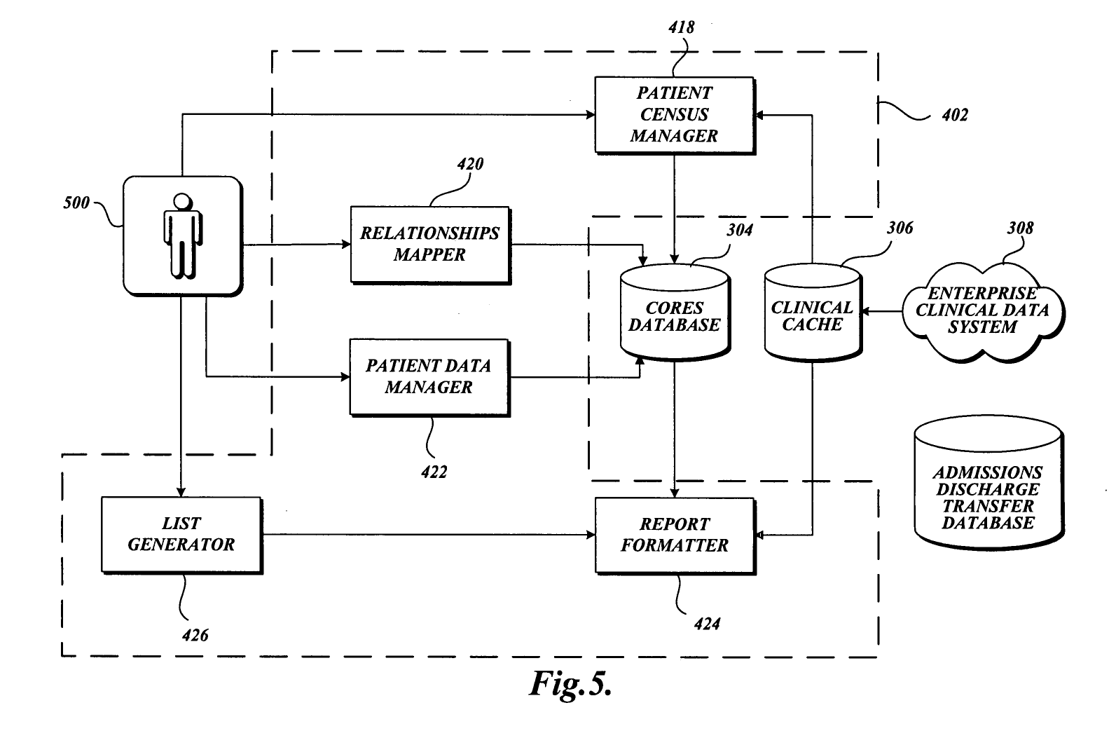

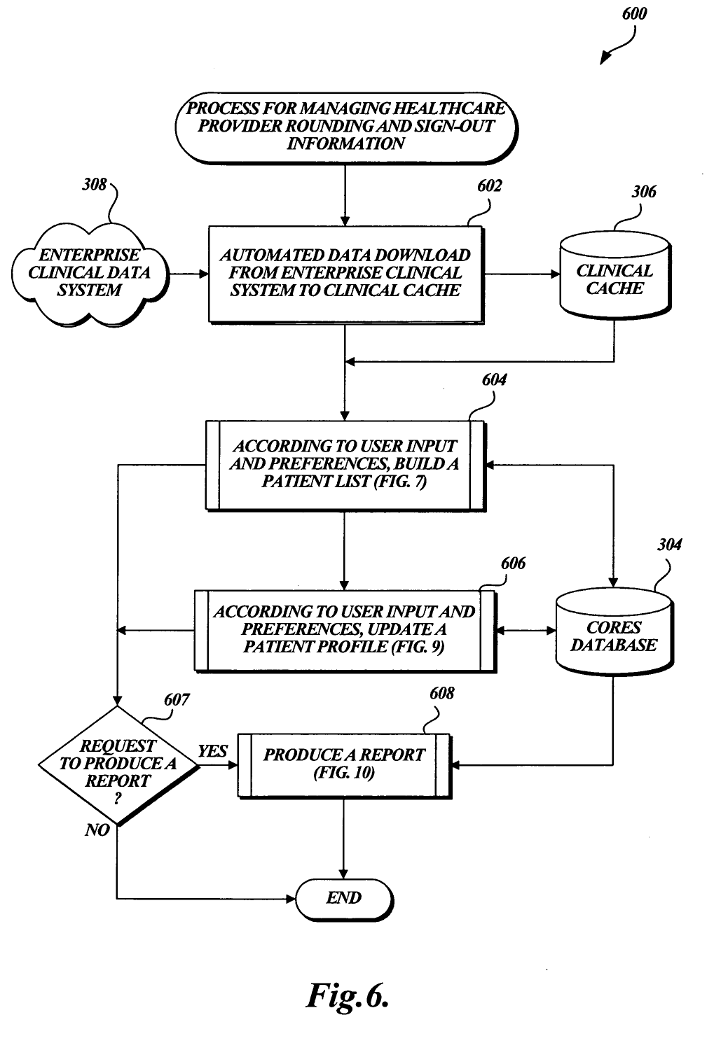

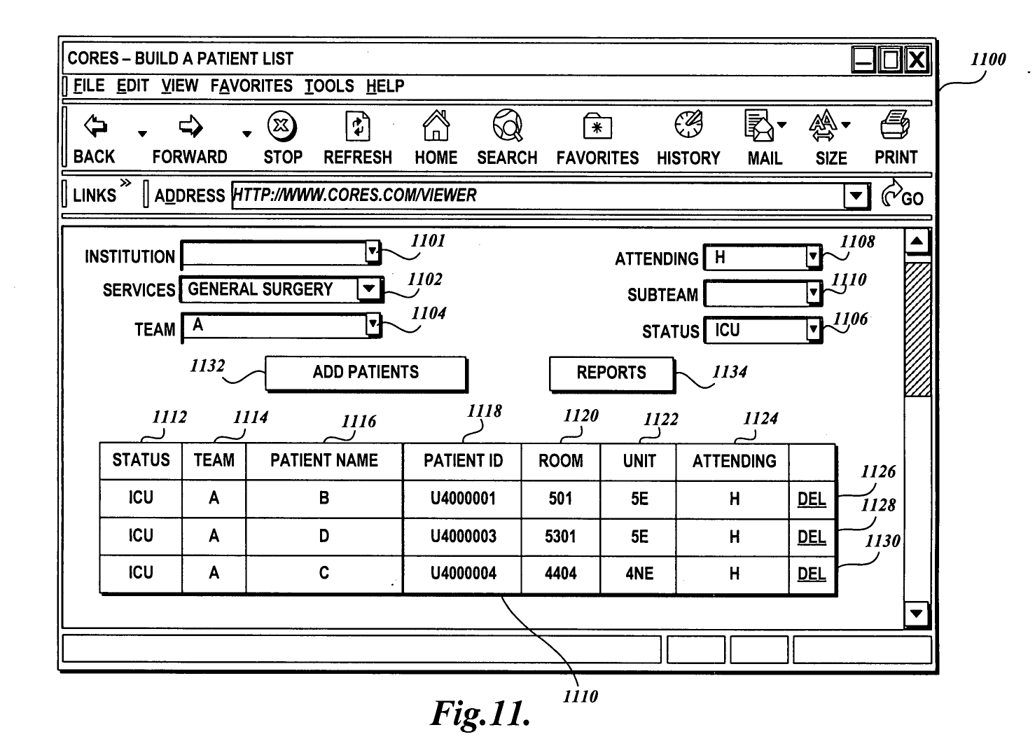

The following text will first describe in detail an exemplary distributed computing system for implementing aspects of the invention, with reference to FIG. 3. Then an exemplary single computer system containing exemplary software components implementing aspects of the invention is described, with reference to FIGS. 4-5. Further, an exemplary process and exemplary routines for a role-based approach for managing patient care information are described, with reference to FIGS. 6-10. Finally, exemplary user interfaces for a user to input information for role-based management of patient care information are described, with reference to FIGS. 11-14.

FIG. 3 is a pictorial diagram illustrating a distributed computing system (“CORES system”) 300 for a role-based management of patient care information generated by healthcare providers, such as rounding and sign-out information, formed in accordance with aspects of the invention. In accordance with one embodiment of the invention, the CORES system 300 enables healthcare providers to perform the following tasks related to rounding and sign-out: (a) manage individual lists of patients and/or lists of patients belonging to a healthcare providing team; (b) store notes, impressions, “to do” lists, and other information for each patient (“patient care information”), which may include information that is not part of an institutionally-defined medical record; (c) link the stored information with patient records existing in other computerized data sources, such as an enterprise clinical data system; (d) produce physical or electronic reports containing information input by the healthcare provider and imported from such other computerized data sources; and (e) access and manage patient lists and records remotely via a secure network connection.

As shown in FIG. 3, in one embodiment of the present invention, patient care information such as patient records, rounding information and sign-out information are stored in a central, secure database server 302. In an exemplary embodiment of the invention, the database server 302 controls a pair of databases, i.e., a CORES database 304 and a clinical cache 306. The CORES database 304 stores subjective and objective patient care information and non-medical record comments, including rounding and sign-out information, generated and recorded by healthcare providers. In addition, the CORES database 304 stores one or more patient lists identifying those patients that have been added to a healthcare service, as well as CORES patient records containing healthcare data for those patients. The clinical cache 306 stores subjective and objective healthcare information, including patient information, periodically obtained from an enterprise clinical data system 308. In addition, the clinical cache 306 stores one or more patient lists identifying currently registered patients, as well as patient records containing institutional healthcare data for those patients. Alternatively, in some embodiments of the invention, the CORES database 304 and the clinical cache 306 may be congregated into a single database 307.

The enterprise clinical data system 308 can be any medical information system or clinical information system (“CIS”) that maintains healthcare information for patients including, inter alia, demographic information, laboratory values, nursing care information, etc. In the embodiment of the invention depicted in FIG. 3, the enterprise clinical data system 308 receives input from an admissions discharge transfer (“ADT”) database 310 which tracks patient admission and discharge information, a laboratory results database 312 that maintains test results for patients, and a nursing care database 314 that maintains, among other data, nursing information for patients, such as vital signs readings, prescribed medications, etc. However, those skilled in the art will recognize that the enterprise clinical data system may comprise or receive input from a variety of data sources, including but not limited to, ADT and registration systems, scheduling systems, patient telemetry systems, etc. In one embodiment of the present invention, the clinical cache 306 receives subjective and objective patient observations from the enterprise clinical data system 308 on an hourly basis. However, those skilled in the art will recognize that the clinical cache 306 may be updated more or less frequently without departing from the spirit and scope of the present invention.

The database server 302 is communicatively coupled to an application server 400 which, as will be described in more detail below, implements a CORES program 402 (FIG. 4) formed in accordance with aspects of the invention for managing patient care information, including rounding and sign-out information, generated by healthcare providers, either locally via the application server 400 or remotely from client devices 318A-318C. For example, a healthcare provider may remotely input, modify, and retrieve rounding and sign-out information maintained by the database server 302 via the Internet 316 using a Web browser installed on the client device 318A. As will be appreciated by those skilled in the art, client devices may comprise any type of personal computing device equipped with the necessary hardware and software for connecting to the Internet 316, or other communications network connected directly or indirectly to the application server 400, via either a wired or wireless communication link. Accordingly, such client devices may include for purposes of example, a laptop computer 318A, a personal digital assistant 318B, or a cellular telephone 318C. In addition, such client devices may also be connected to an output device 320 for outputting reports generated by the CORES program 402 stored upon the application server 400 and downloaded via the Internet 316 to the client devices 318A-318C. Although pictorially represented in FIG. 3 as a printer, those skilled in the art will recognize that the output device 320 may take the form of a hardware component such as a printer, plotter, or portable device (upon which generated reports may be displayed), or an output file that may be saved to a disk, or attached to or comprising an electronic mail message, electronic paging message, or other such communication mechanism.

FIG. 4 illustrates the application server 400 upon which the CORES program 402 may be installed. Those skilled in the art will appreciate that the application server 400 may include more or fewer components than those shown in FIG. 4. However, it is not necessary that all of those generally conventional components be shown in order to disclose an enabling embodiment of the present invention. In addition, FIG. 4 and the following discussion is intended to provide a brief, general description of a computing system suitable for implementing various features of the invention. While the computing system will be described in the general context of a server computer usable as a stand-alone computer, or in a distributed computing environment where complementary tasks are performed by remote computing devices linked together through a communication network, those skilled in the art will appreciate that the invention may be practiced with many other computer system configurations, including multi-processor systems, mini-computers, mainframe computers, and the like. In addition to the more conventional computer systems described above, those skilled in the art will recognize that the invention may be practiced on other stand-alone or embedded computing devices with sufficient memory and computing power. Moreover, while aspects of the invention may be described in terms of programs executed by a server computer, those skilled in the art will recognize that those aspects also may be implemented in combination with other program modules. Generally, program modules include routines, programs, components, data structures, etc., that perform particular tasks or implement particular abstract data types.

With reference to FIG. 4, the application server 400 includes a processing unit 404, a memory 410, and a system bus 428 that couples the memory 410 to the processing unit. The memory 410 is connected via the system bus 428 to an optional display device 408 and a network interface 406. It will be appreciated that the application server 400 is connected to the Internet 316 (FIG. 3), or other communications network, through the network interface 406. The memory 410 generally comprises read-only memory (ROM), random-access memory (RAM), and permanent mass memory such as hard disk drive, tape drive, optical drive, floppy disk drive, or combination thereof. The memory 410 contains the operating system 412 for controlling operation of the server 400. As is known to those of ordinary skill in the art, the operating system may be formed by a general-purpose server operation system such as a Microsoft® server operating system, UNIX operating system or LINUX™ operating system.

The memory 410 also stores the program code and data for providing a Web site that allows healthcare providers to manage (i.e., retrieve, modify, display, etc.) the healthcare information stored in the CORES database 304 and the clinical cache 306. Thus, the memory 410 may store a Web server application 414, which may be any one of a number of commercially available or open source software packages. The Web server application 414 comprises computer-executable instructions that, when executed by the server 400, generate configurable markup documents, such as the sample Web pages shown in FIGS. 11-14. The Web server application 414 may also be configured to communicate with a commercially available or open source database application 416 to facilitate the transfer of data to and from the CORES database 304 and the clinical cache 306. The memory 410 may also store other software components such as the CORES program 402 to facilitate the functions of the invention. It will be appreciated that these software components may be stored on a computer-accessible medium and loaded into the memory 410 of the server computer 402 using a drive mechanism associated with the computer-accessible medium, such as a floppy drive, a CD-ROM drive, etc. Such computer-accessible media may include magnetic and/or optical media, removable and non-removable media, hard disks, CD-ROMs, DVDs, magnetic cassettes, flash memory cards, digital video disks, Bernoulli cartridges, ZIP disks, and the like.

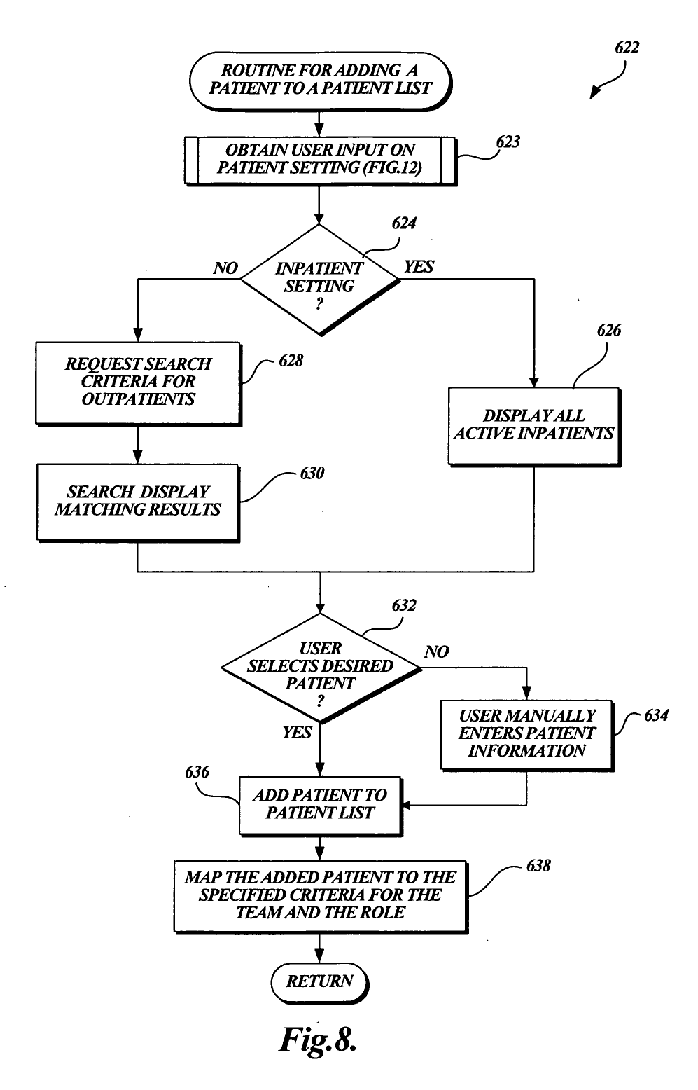

As also shown in FIG. 4, in an exemplary embodiment of the invention, the CORES program 402 comprises a number of program modules which in combination provide for the management of healthcare information, including rounding and sign-out information. More specifically, the CORES program 402 comprises a patient census manager 418 for manually creating a CORES patient record for a patient (if a patient record does not already exist in the clinical cache 306). The patient census manager 418 also provides for automatic creation of a CORES patient record (if a patient record already exists in the clinical cache 306) by copying data from the patient record stored in the clinical cache 306. Finally the patient census manager 418 also provides for modification of a patient record already created either manually or automatically and stored in the CORES database 304. FIG. 8 is a flow diagram illustrating exemplary operations performed by the patient census manager 418 and will be described in detail later.

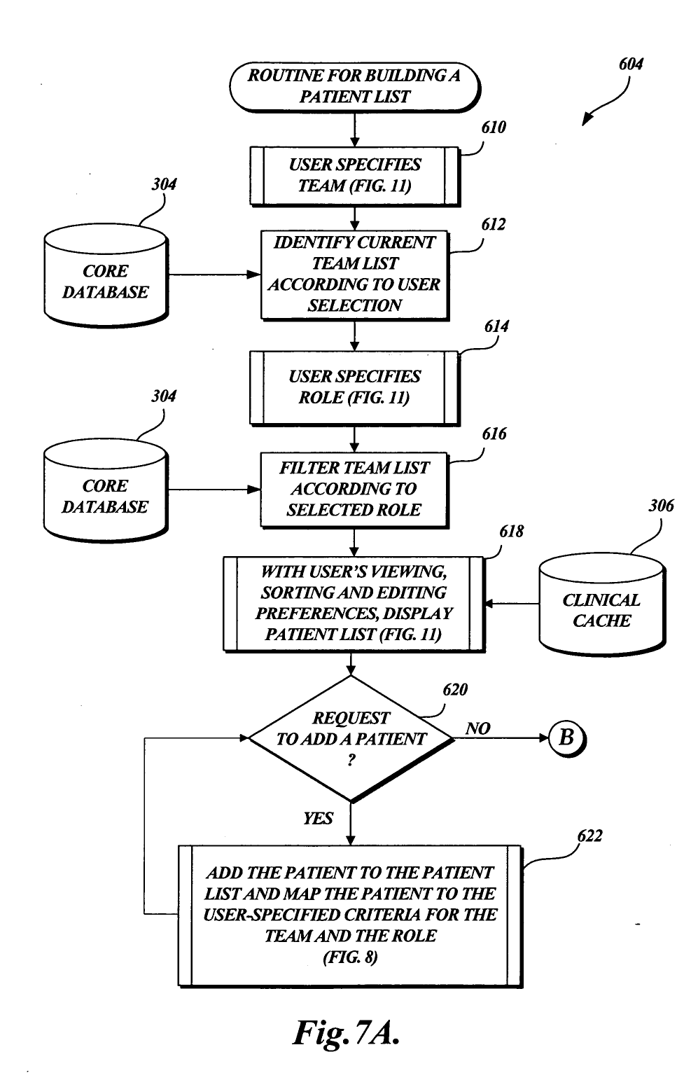

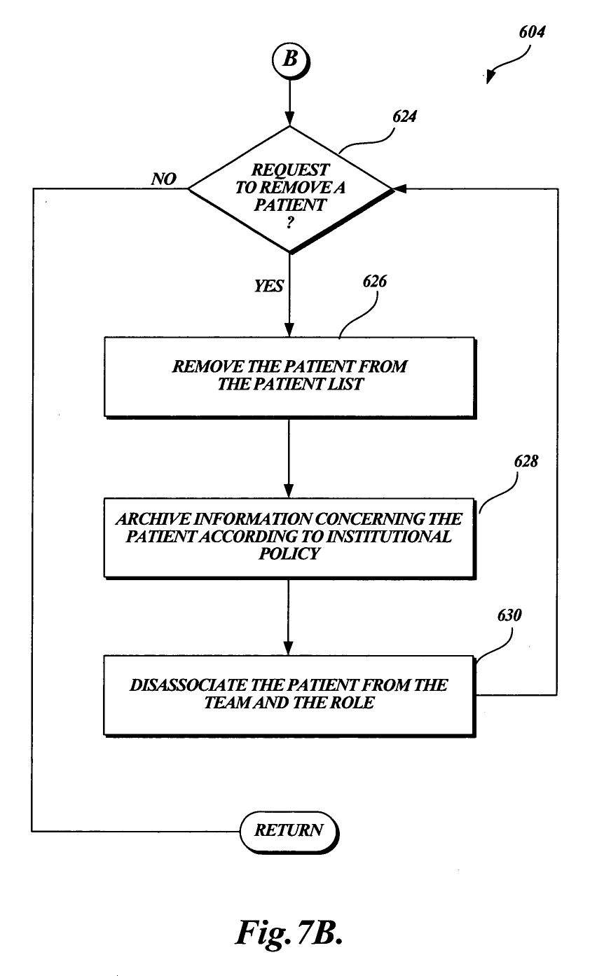

The CORES program 402 also comprises a relationships mapper 420 for entering and updating relationships between individual patients, healthcare providing teams, and the members of those teams. Those skilled in the art will appreciate that relationships between patients and providers may include both persistent relationships such as “primary care provider” and transient relationships such as “primary team,” “consult service,” “first call resident,” “attending physician,” and “chief resident.” FIGS. 7A-7B are a flow diagram illustrating exemplary operations performed by the relationships mapper 420 and will be described in detail later.

The CORES program 402 also includes a patient data manager 422 for adding, modifying, and retrieving patient care information such as non-medical record comments, and objective and subjective rounding and sign-out information generated by healthcare providers for the patient. This information includes observations that are not available from other computer systems through the clinical cache 306, but instead are those entered by healthcare providers. It is contemplated that certain data elements are specific to each team of providers taking care of the patients while other data elements are shared between all users of the CORES system 300. In embodiments of the invention, team-specific non-medical record comments regarding a patient, such as provider-to-colleague notes and “to do” lists are associated with the specific team by default, unless the team agrees to share such information with another team caring for the patient. FIG. 9 is a flow diagram illustrating exemplary operations provided by the patient data manager 422 and will be described in detail later.

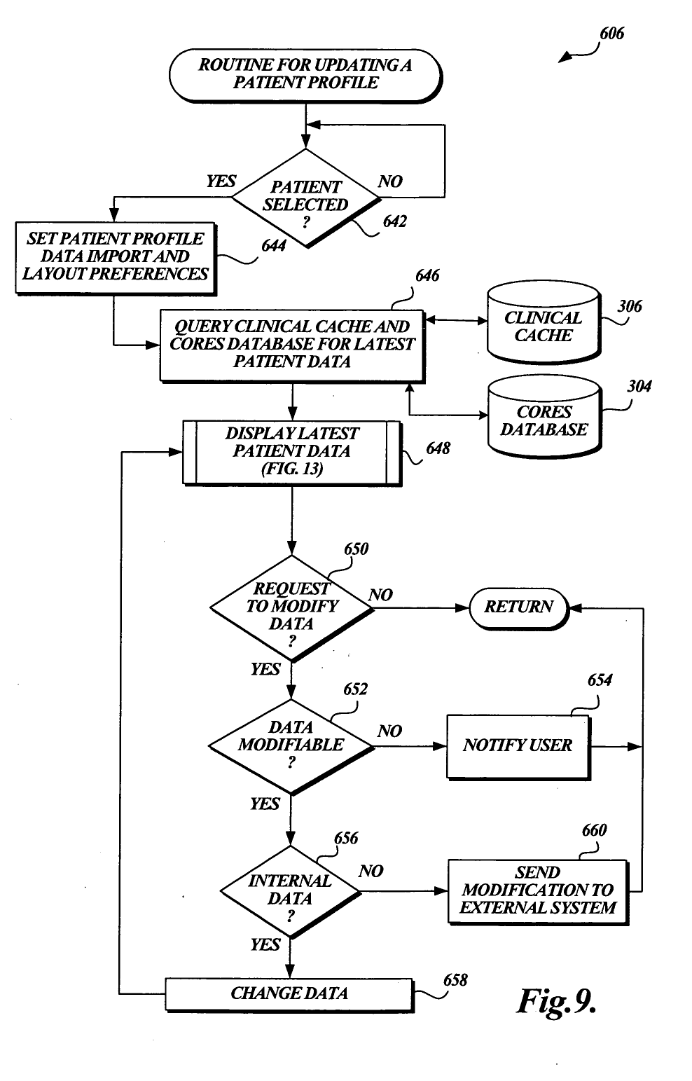

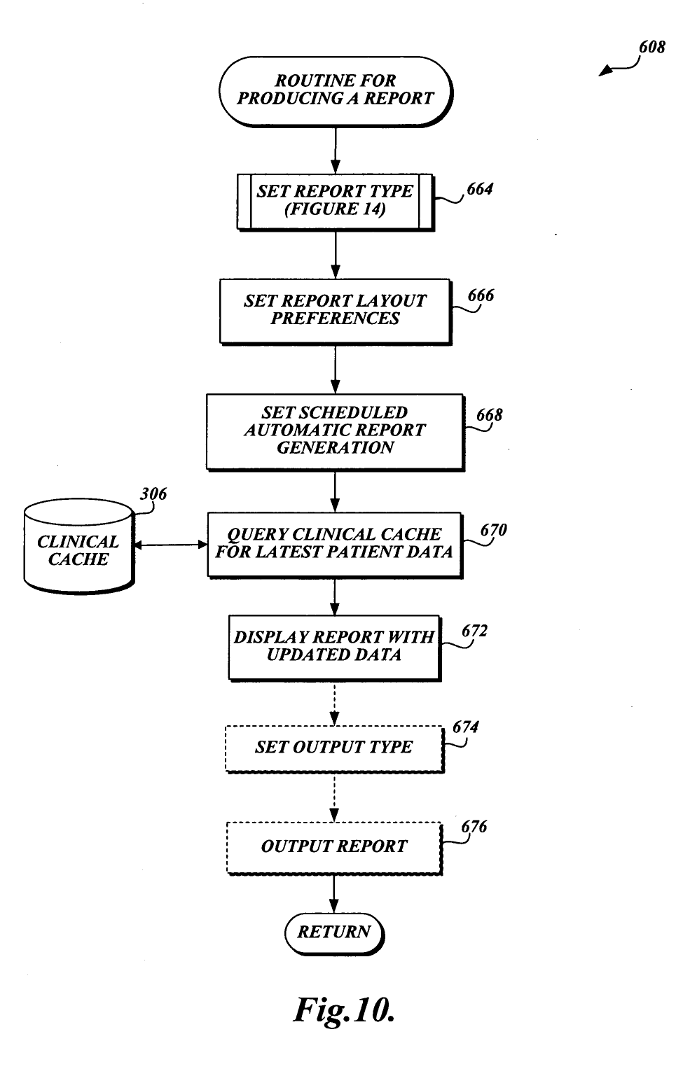

A report formatter 424 may also be provided for generating standard and customized reports. Such reports may, for example, combine the non-medical record comments, the subjective and objective provider-entered healthcare information, including rounding and sign-out information stored in the CORES database 304 with the subjective and objective institutional healthcare information, including patient information, stored in the clinical cache 306. The report formatter 424 produces a variety of formatted reports tailored to specific areas of clinical practice and daily workflow to support concise review and presentation of results and progress (rounding), transfer of care (sign-out), and documentation (notes). FIG. 10 is a flow diagram illustrating exemplary operations provided by the report formatter 324 and will be described in detail later. Finally, a list generator 426 may be provided for generating patient lists for use in creating the reports noted above.

FIG. 5 provides a general overview of the operation of the various components of the CORES program 402 described above. In the illustrated embodiment, a healthcare provider 500 gains access to the CORES program 402 via a Web browser installed on a client device such as the client device 318A. Typically, the healthcare provider 500 may be a member of a team (e.g., general surgery team, medicine team, hand surgery team, etc.) who works with and treats patients on a day-to-day basis in a clinical setting to provide a particular medical care or medical consult service (e.g., orthopedics, general surgery, etc.). Such healthcare providers may have roles including, but not limited to, attending physicians, resident physicians, hospitalists, consultants, nurse practitioners, trainees, students, interns, physician assistants, ancillary care providers (such as respiratory therapists, dietitians, etc.) and, occasionally, administrative personnel. Typically, a healthcare provider 500 will access the CORES program 402 at the beginning of his or her daily work routine, i.e., before he or she begins rounding. Typically, the healthcare provider 500 accesses the CORES program 402, uses the list generator 426 to generate a list of patients (“patient list”) assigned to that healthcare provider's team, the role the healthcare provider 500 is fulfilling, and generates a report(s) for the patients identified on the patient list using the report formatter 424. The report formatter 424 retrieves the previous rounding and sign-out information stored in the CORES database 304 and patient information stored in the clinical cache 306 for those patients identified by the list generator 426 and formats the retrieved information into predetermined report formats requested by the healthcare provider 500 and/or into customized reports requested by the healthcare provider 500.

The reports generated by the report formatter 424 will typically include the subjective and objective information and stored in the clinical cache 306 as well as the non-medical record comments, and subjective and objective information entered by previous healthcare providers that have treated the patient and signed out using the CORES program 402. The healthcare provider 500 may then use the generated reports to prepare for his or her rounding with the patient. At any time during the day, the healthcare provider 500 may return to the CORES program 402 and input additional information or observations gathered by the healthcare provider 500 during the course of his or her rounding. In addition, when nearing the end of his or her shift, the healthcare provider 500 may access the CORES program 402 and input any sign-out information that is necessary and appropriate to transfer coverage of care of a patient to another healthcare provider, typically another member of the team. The sign-out information is stored in the CORES database 304 and available for subsequent reports generated by the report formatter 424.

The healthcare provider 500 may access the CORES program 402 and add, modify or retrieve information regarding a particular patient. In accordance with one aspect of the invention, the healthcare provider 500 may add or retrieve healthcare information, including patient information to or from the clinical cache 306 using the patient census manager 418. If the patient has already been admitted, the patient's CORES record may have already been retrieved from the enterprise clinical data system 308 and added to the clinical cache 306. Accordingly, using the patient census manager, the healthcare provider 500 would be able to retrieve a preexisting CORES patient record for the patient. If no such record is found, the healthcare provider 500 may create a CORES patient record for a patient using the patient census manager 418.

Following addition, modification or retrieval of a patient record using the patient census manager 418, the healthcare provider 500 may use the relationships mapper 420 to map a particular patient to a healthcare providing team. As will be appreciated by those skilled in the art, in many clinical settings, a patient shall be treated by a team of healthcare providers providing a particular service. For example, a patient may be treated by an attending physician who guides the general treatment of the patient, but who has a team of healthcare providers who work with a patient on a day-to-day basis. The healthcare providers in the team fill different roles of providing healthcare service. For example, the attending physician may be supported by a team including a senior resident, a hospitalist(s), nurse practitioner(s), physician assistant(s), junior resident(s), and medical student(s). Accordingly, using the relationships mapper 420, the healthcare provider 500 may assign any patient to a particular team, or several particular teams, of healthcare providers. In one embodiment of the invention, authorized members of a team can access the CORES program 402 to generate reports containing any or all patients assigned to that team. In addition, a given patient might be assigned to more than one team. For example, a patient admitted to a surgical team may be assigned to the surgical team in the CORES program 402 using the relationships mapper 420. That same patient might be seen in consultation by a medical team, and may be assigned by a medical team member to the medical team in the CORES program 402. Each team may manage separate records of provider-entered, non-medical record comments stored in the CORES database 304, but both teams would receive identical institutional healthcare information about that patient from the clinical cache 306.

Once a patient has been assigned to a team using the relationships mapper 420, the healthcare provider 500 may utilize the patient data manager 422 to add, modify and retrieve the non-medical record comments, and the subjective and objective rounding and sign-out information generated by the healthcare provider during rounding and/or sign-out. As noted above, the report formatter 424 combines such information generated by healthcare providers and stored in the CORES database 304 with the institutional healthcare information stored in the clinical cache 306 to generate a report for each patient that may be utilized by the present healthcare provider 500 and/or a subsequent healthcare provider to whom temporary care coverage is being transferred. Those skilled in the art will appreciate that the reports generated by the report formatter 424 can be of virtually any type or format without departing from the spirit and scope of the present invention. In addition, the reports are organized so as to present the information from a healthcare provider's perspective, i.e., the reports are “healthcare provider centered” and contain summary information regarding many patients, as opposed to “patient centered” records such as a patient chart, which contains comprehensive information about only one patient.

Specific operations of the CORES program 402 and the CORES system 300 are illustrated in FIGS. 6-10, which are flow diagrams illustrating exemplary process and routines for role-based management of healthcare provider rounding and sign-out information. A description of these processes and routines will be provided with reference to the CORES system 300 and its exemplary components illustrated in FIGS. 3-5.

FIG. 6 is a flow diagram illustrating an exemplary process 600 implementing a role-based approach for managing healthcare provider rounding and sign-out information. As noted above with regard to FIG. 3, the CORES system 300 may include the clinical cache 306 that stores healthcare information obtained from the enterprise clinical data system 308. In an exemplary embodiment of the invention, the process 600 automatically downloads data from the enterprise clinical data system 308 to the clinical cache 306. See block 602. Such an automated data download may occur periodically according to a pre-specified schedule. Such an automated data download may also occur in real time upon receiving a request from the system or from a user who needs specific patient data in the enterprise clinical data system 308.

The process 600 then executes a routine 604 to build a patient list. See block 604. FIGS. 7A-7B provides an exemplary implementation of the routine 604 and will be described in detail later. A patient list contains patients that are assigned to both a team and a specific role in the team. The routine 604 builds the patient list by choosing patients from current active patients in the clinical cache 306 according to specific list criteria. Such list criteria may come from user input. Such user input and preferences enable the routine 604 to identify patents associated with a specific role in a team. An exemplary embodiment of the invention provides a Web-based user interface that enables a user, i.e., a healthcare provider, to input data and preferences. FIG. 11 illustrates such a user interface and will be described in detail later.

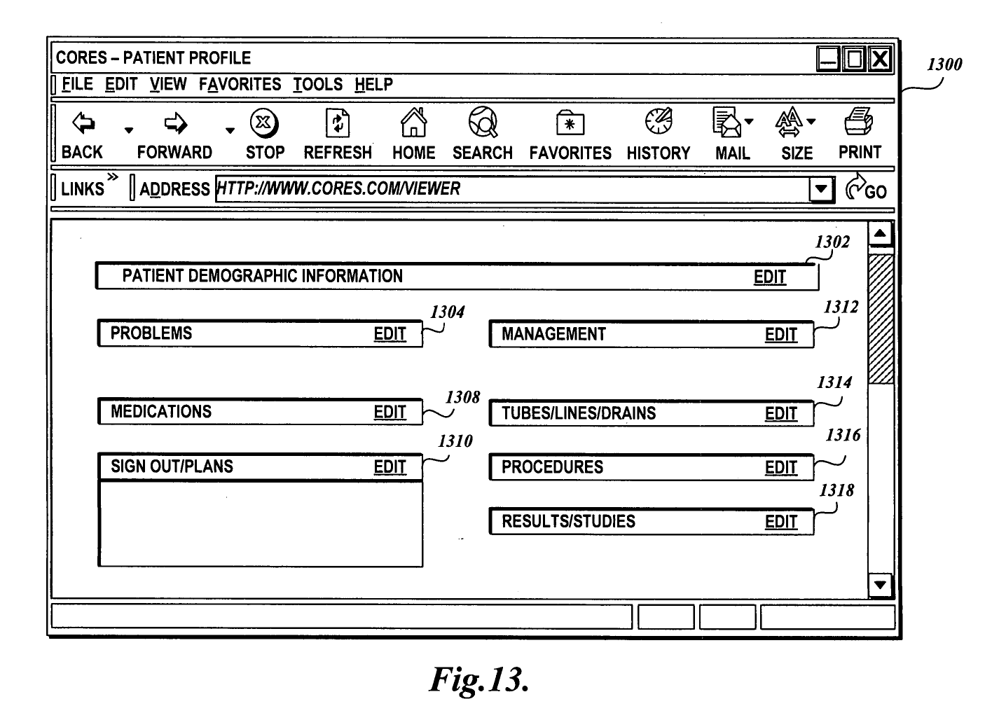

After executing the routine 604 to build a patient list according to user input and preferences, the process 600 may proceed to execute a routine 606 that updates the patient profile for a patient in the patient list according to user input. See block 606. FIG. 9 illustrates an exemplary implementation of the routine 606 and will be described in detail later. In one embodiment of the invention, one user's non-medical record comments about a patient are usually kept separately from another user's information about the same patient, unless the two users choose to synchronize the records. In another embodiment of the invention, inputs about a patient by different healthcare providers in the same team are shared within the team, but are not shared with another team. Alternatively, in another embodiment of the invention, input by different healthcare providers about a patient is shared among all teams that provide healthcare services to the patient. FIG. 13 illustrates an exemplary user interface where a user may input data to update a patient profile and will be described in detail later.

In an exemplary embodiment of the invention, while executing the routines 604 and 606, the process 600 retrieves information from the CORES database 304 and deposits the resultant patient list and patient profiles to the CORES database 304.

After executing the routine 604 to build a patient list, and/or the routine 606 to update a patient profile, upon receiving a user request, the process 600 may execute a routine 608 to produce a report for the patient list and/or the patient profile by retrieving information deposited in the CORES database 304. See block 608. FIG. 10 illustrates an exemplary routine 608 and will be described in detail later.

As noted above, FIGS. 7A-7B are a flow diagram illustrating an exemplary routine 604 for building a patient list according to specific criteria. Such criteria may be provided by a user through a user interface such as the Web-based user interface illustrated in FIG. 11. Preferably, the routine 604 starts by providing a security login for a user. In an exemplary embodiment of the invention, when a user initially logs in to the CORES system 300, the user first inputs information to identify the team that provides a particular healthcare service for one or more patients. See block 610. This information may identify the institution where the team of interest exists. The institution can be hospital wards, a hospital itself, or an entire clinic network. This information may also identify the healthcare services provided by the team. The services can be general surgery, family medicine, internal medicine, etc. This information shall identify the name of the team. According to this information, the routine 604 proceeds to query the CORES database 304 to identify patients (“team list”) assigned to the team. See block 612.

The routine 604 then accepts user-specified information specifying a role in the team. See block 614. In an exemplary embodiment of the invention, information defining a role may identify a sub-team, such as Supervising Fellow, Intern A, ICU Resident. Such information may also identify a specific attending physician and/or the acuity level. Upon receiving such information, the routine 604 proceeds to identify the role and to filter the current team list according to the role. See block 616. The resultant patient list thus includes patients assigned both to the team and the role in the team. Preferably, before or after importing a patient list according to the specified criteria, the routine 604 sets user preferences for the patient list such as list viewing, sorting, and editing preferences. The routine 604 thus can display the patient list according to the user preferences. See block 618.

Upon viewing the displayed patient list, a user may request to add or remove one or more patients. The routine 604 determines whether it receives a request to add a patient to the patient list. See decision block 620. If the answer to decision block 620 is YES, the routine 604 proceeds to execute a routine 622 to add the patient to the patient list and assign to the patient the specified criteria associated with the patient list. The specified criteria include the information used to identify the team and the role that the patient list is associated with. See block 622. FIG. 8 is a flow diagram illustrating an exemplary routine 622 and will be described in detail later. After executing the routine 622, the routine 604 loops back to decision block 620 to check if it has received another request to add a patient. If the answer to decision block 620 is NO, the routine 604 proceeds to a continuation terminal B.

From the continuation terminal B (FIG. 7B), the routine 604 determines if the user elects to remove a patient. See decision block 624. If the answer to decision block 624 is YES, the routine 604 removes the patient from the patient list. See block 626. In exemplary embodiments of the invention, the routine 604, according to institutional policy, may also archive any of the unique, provider-entered non-medical record comments, subjective and/or objective patient care information currently associated with that patient in the CORES database. See block 628. Preferably, the archived data can be stored in the CORES database 304 or another database. The archived data may be stored in such a fashion that re-adding the patient to this particular team list will restore the archived data to active use in the CORES database 304 and again display them and include them on reports. In addition, the routine 604 disassociates the patient from specified criteria for the team and the role. See block 630. The disassociation only disconnects the patient from the currently selected team while leaving the patient on any other team lists it maps to. The routine 604 then loops back to decision block 624 to check if it has received another request to remove a patient. If the answer to decision block 624 is NO, the routine 604 returns.

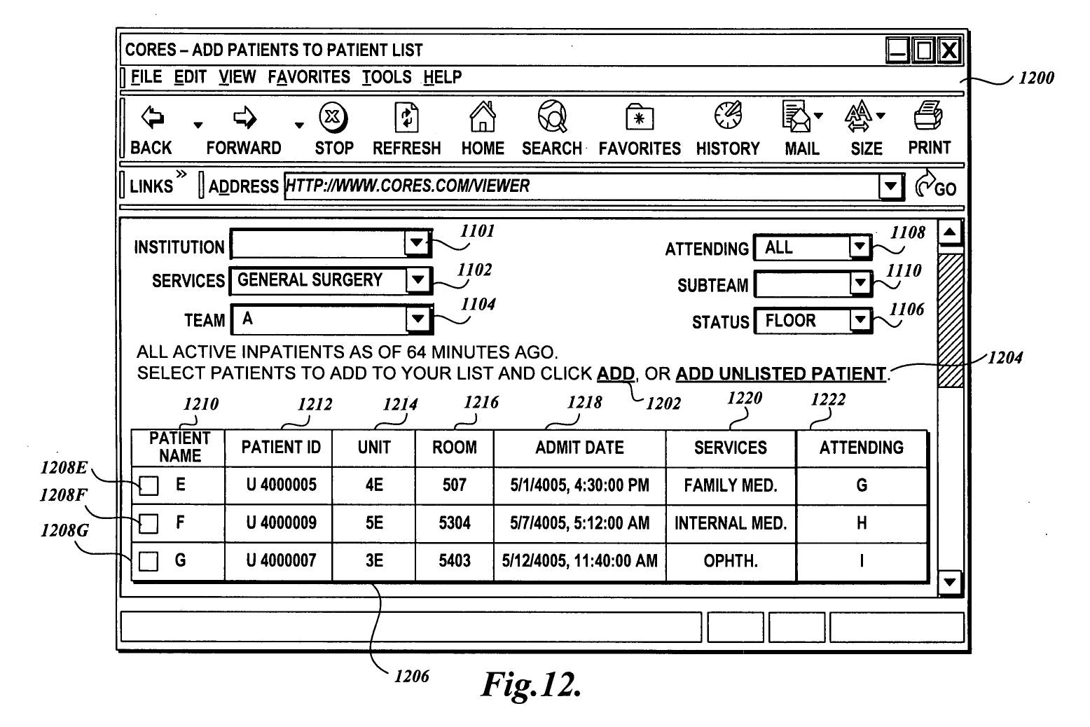

FIG. 8 illustrates an exemplary routine 622 that adds a patient to a patient list. Preferably, the routine 622 first obtains user input on the setting of the to-be-added patient. See block 623. The setting of a patient identifies whether the patient is an inpatient or an outpatient. FIG. 12 is a user interface through which a user can specify information for adding a patient to a patient list and will be described in detail later. Information concerning patient settings is provided by the patient census manager 418 (FIG. 4). The routine 622 then determines whether patient setting is inpatient. See decision block 624. If the answer to decision block 624 is YES, the routine 622 proceeds to display all active inpatients, for example, by querying an institutional patient database. See block 626. If the answer to decision block 624 is NO, meaning that the patient is an outpatient, the routine 622 requests search criteria for outpatients. See block 628. The search criteria for outpatients may include the name, date of birth, patient number, and/or any other criteria for identifying user-preferred outpatient list. The routine 622 may search specific institutional patient database(s) and displays any matching results. See block 630. After displaying either the active inpatients or the outpatients matching specific search criteria, the routine 622 proceeds to determine whether the user has selected a patient to add. See decision block 632. If the answer is NO, the routine 622 may ask the user to manually enter information for the patient that the user desires to add. See block 634. The added patient may then be included in the patient list. See block 636. If the answer to decision block 632 is YES, meaning that the user selects a patient in the displayed inpatients or outpatients, the routine 622 adds the selected patient to the patient list. See block 636. The routine 622 then marks the added patient to the criteria that are used to identify the team and the role associated with the patient list. See block 638. The routine 622 then returns.

FIG. 9 illustrates an exemplary routine 606 for updating a patient profile. Preferably, upon viewing a patient list, such as the patient list resulting from executing the routine 604, a user may select a patient in the patient list. The routine 606 first determines whether a patient has been selected by a user. See decision block 642. If the answer is NO, the routine 606 does not proceed further. If the answer is YES, the routine 606 proceeds to set user-specified preferences for importing patient profile data and displaying the patient profile data. See block 644. The routine 606 then proceeds to query the CORES database 304 and clinical cache 306 for the latest patient data. See block 646. The routine 606 then displays the latest patient data according to the patient profile data layout preference. See block 648. FIG. 13 illustrates an exemplary user interface that displays the patient profile data and will be described in detail later.

In an exemplary embodiment of the invention, at this stage, a user may perform various operations on the patient profile data. For example, a user may choose to output the patient profile data, produce a report on the patient profile data, reconfigure the patient profile preferences, view the patient list from which the patient was selected, or change the criteria that have generated the patient list. For instance, a user may request to modify the patient profile data. The routine 606 thus determines if it has received a request to modify the patient profile data. See decision block 650. If the answer is NO, the routine 606 returns. If the routine 606 does receive a request to modify the patient profile data, the routine 606 proceeds to determine whether the data is modifiable. See decision block 652. In an exemplary embodiment of the invention, at least some of the patient profile data cannot be modified. Such patient profile data includes, for example, laboratory values, vital signs, the patient's name and medical record number, etc. If the answer to decision block 652 is NO, meaning the data cannot be modified, the routine 606 notifies the user and returns. See block 654. If the data is modifiable, the routine 606 proceeds to determine whether the data is internal data. See decision block 656. In an exemplary embodiment of the invention, internal data are data local to the CORES database 304, and may include, for example, the reason for consulting on or admitting a patient, or a current subset of a list of patient medical problems. Data imported from the enterprise clinical data system 308 are external data, and may include, for example, a current list of family contacts for a patient, or the institution-assigned attending physician. If the data are internal data, the routine 606 proceeds to change the data according to user input. See block 658. The routine 606 then loops back to block 648 to display the modified patient data. If the answer to decision block 656 is NO, meaning that the data was from an external system, the routine 606 sends the modification to the system that owns the data that has been modified. See block 660. Alternatively, the modification can be sent to the owner of the external system as a request to update or modify the existing external data. The routine 606 then returns.

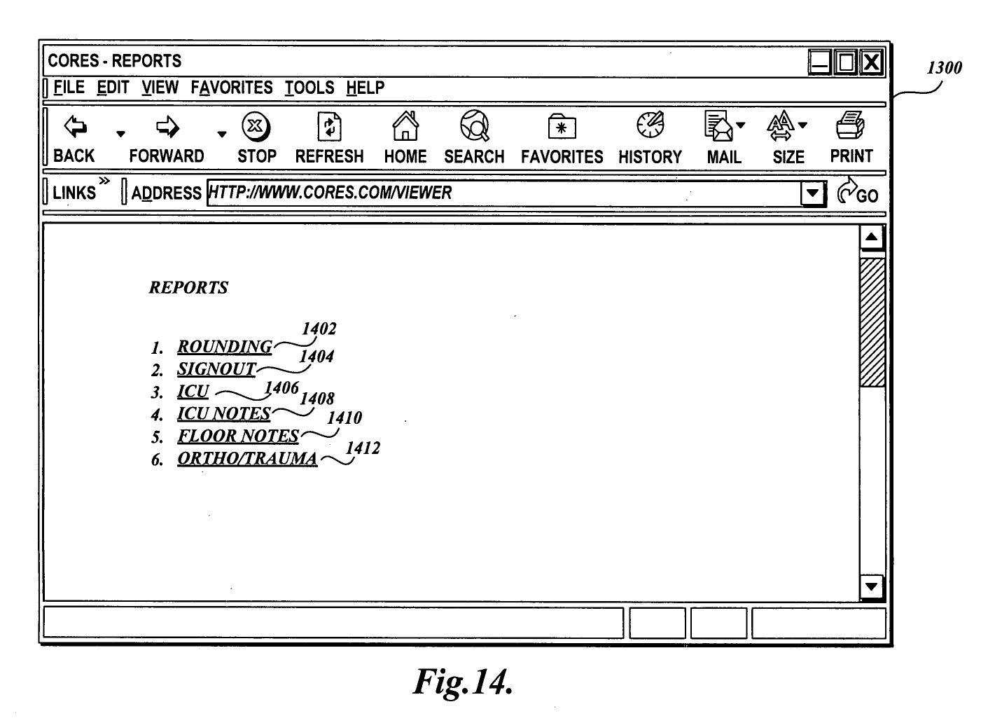

FIG. 10 illustrates an exemplary routine 608 that produces a report concerning a patient or a patient list. The routine 608 starts by setting the report type. See block 664. In an exemplary embodiment of the invention, report type includes rounding report, sign-out report, team-specific non-medical record comments, etc. FIG. 14 is an exemplary user interface illustrating exemplary report types that a user may select before generating a report and will be described in detail later. The routine 608 then proceeds to set the layout preferences for the report. See block 666. Preferably, the routine 608 also sets scheduled automatic report generation, which automatically generates a report according to a pre-specified schedule. See block 668. The routine 608 then queries the clinical cache 306 for the latest patient profile data for the patient that the report is about, or for each patient in the patient list that the report is about. See block 670. The routine 608 then displays the report with the latest patient data retrieved. See block 672. In an exemplary embodiment of the invention, a report is generated through a report compositor, which may be PDF generation software, HTML generator, word processor, or any other output style. A report may be a viewable report, which can be viewed on workstations, clients, wireless devices, or via secured Internet logins from any Internet capable device. A report can also be a printed paper report. In addition, a report can also be returned to the clinical cache 306 to be stored there.

Preferably, after a report has been generated, a user may select to output the report. In such a case, the routine 608 may further include setting the output type. See block 674. An output type may be to print the report, or to synchronize the report data to a portable device, to email the report, or to save the report to permanent storage, etc. The routine 608 then outputs the report according to the specified output type. See block 676. The routine 608 then returns.

As noted above, FIG. 11 is a pictorial diagram illustrating a browser program with an exemplary Web page presenting a user interface 1100 in accordance with an embodiment of the invention. The user interface 1100 enables a user to input information for building a patient list. As illustrated in FIG. 11, the user interface 1100 includes multiple list criteria, based on which a patient list can be generated. For example, the user interface 1100 includes list criteria such as institution 1101 that specifies the healthcare institution in which a team exists, services 1102 that specify the healthcare function that a team provides. The user interface 1100 also includes list criteria identifying the name of the team 1104, the name of the attending physician 1108. These list criteria define the team for the patient list. Furthermore, the user interface 1100 also includes list criteria defining the role for the patient list. Such role-related list criteria include sub-team 1110, which can be Supervising Fellow, Intern A, ICU Resident, etc. Another role-related list criterion is status 1106, which indicates the acuity level such as intensive care unit (“ICU”), floor level, sub-acute care, or outpatient.

When a user inputs values for these list criteria, the user interface 1100 further displays a table 1110 that displays the patient list containing the patients in the current clinical cache 306 that match the specified list criteria values. As shown in FIG. 11, the table 1110 identifies the status 1112, the team name 1114, the patient name 1116, the patient ID 1118, the room 1120, the unit 1122, and the attending physician 1124 of each patient that matches the specified list criteria. Furthermore, for each entry in the table 1110, the user interface 1100 further includes a UI item, such as UI item 1126, 1128, 1130, which enables a user to delete a patient from the patient list. The user interface 1100 further includes a UI item “Add Patients” 1132 that enables a user to add patients to the patient list. The user interface 1100 may further include an UI item Reports 1134, the actuation of which generates reports on the patient list or a patient in the patient list.

FIG. 12 illustrates an exemplary user interface 1200 that enables a user to input to add one or more patients to a patient list, such as the patient list in the table 1110 illustrated in FIG. 11. Upon a user actuating the Add Patient button 1132 (FIG. 11), the user interface 1200 is displayed. In an embodiment of the invention, by default, if the CORES system 300 is in an inpatient setting, the user interface 1200 will display a table 1206 of active inpatients. If the CORES system is in an outpatient setting (clinic, skilled nursing facility, etc.) the user interface 1200 may display a list of active outpatients, or today's clinic roster. In FIG. 12, the table 1206 displays the patient name 1210, the patient ID 1212, the patient unit 1214, the room number 1216 for each active inpatient. The table 1206 may also include information such as admit date 1218, service 1220, and attending physician 1222. A user may select a checkbox, such as the checkbox 1208E, 1208F, or 1208G, to select a patient in the table 1206 and add the patient to the current patient list by actuating the Add link 1202. Alternatively, a user may add patients not listed in table 1206 by actuating the Add Unlisted Patient link 1204. The actuation of the link 1204 may open up another Web page that requests the user to manually enter patient information, or to set search criteria for patients that are in outpatient facilities.

As noted above, FIG. 13 is a pictorial diagram illustrating a browser program with an exemplary Web page presenting a user interface 1300 for a user to view and edit patient profile data for a specific patient. As shown in FIG. 13, a user may view and edit patient profile information such as patient demographic information 1302, patient health problems 1304, medication information 1308, patient health management information 1312, lab testing information such as tubes/lines/drains 1314, procedure information 1316, and results/studies 1318. In exemplary embodiments of the invention, the user interface 1300 includes a text input box sign-out/plans 1310 that allows a healthcare provider to provide non-medical record comments for a patient.

As noted above, FIG. 14 is a pictorial diagram illustrating a browser program with an exemplary Web page presenting a user interface 1400 that allows a user to define the type of a report that is to be generated. As shown in FIG. 14, a report can be a rounding report 1402 that would display the rounding information for a patient. A report can be a sign-out report 1404 that displays any sign-out information for a patient. In addition, a report can be a service-specific report such as an ICU report 1406. A report can also display all the non-medical record comments related to a patient or to a specific service or unit. For example, the user interface 1400 includes report types such as ICU notes 1408 and floor notes 1410. In addition, a report can also be generated to display all information related to a particular medical problem such as ortho/trauma 1412.

While the preferred embodiment of the invention has been illustrated and described, it will be appreciated that various changes can be made therein without departing from the spirit and scope of the invention.

1. A computer-implemented method for role-based management of patient care information for a plurality of patients, comprising:
associating at least one (“team list”) of the plurality of patients to a team comprising a plurality of roles, wherein a role can be fulfilled by a healthcare provider;
associating at least one (“role list”) of the plurality of patients to a role;
identifying the team list associated with the team, upon receiving information specifying the team; and
identifying one or more patients (“patient list”) in the team list who are associated with one of the plurality of roles in the team, upon receiving information identifying the role in the team.

2. The computer-implemented method of claim 1, further comprising:
associating with the team any non-medical record comments provided by the team for the at least one of the plurality of patients in the team list.

3. The computer-implemented method of claim 1, further comprising:
adding a patient to the patient list, upon receiving a request; and
mapping the patient with the team and the role in the team.

4. The computer-implemented method of claim 1, further comprising:
removing one of the one or more patients from the patient list, upon receiving a request; and
disassociating the patient from the team and the role in the team.

5. The computer-implemented method of claim 4, further comprising:
archiving patient care information for the patient, wherein the archived patient care information is retrieved if the patient is later restored to the team list.

6. The computer-implemented method of claim 1, further comprising:
displaying patient care information for one of the one or more patients in the patient list.

7. The computer-implemented method of claim 1, further comprising:
updating patient care information for one of the one or more patients in the patient list according to input from a healthcare provider fulfilling the role in the team.

8. The computer-implemented method of claim 7, wherein the patient care information for the patient includes non-medical record comments provided by the healthcare provider.

9. The computer-implemented method of claim 1, further comprising:
producing a report for the patient list, upon receiving a request.

10. The computer-implemented method of claim 1, further comprising:
producing a report for one of the one or more patients in the patient list, upon receiving a request.

11. A software system for role-based management of patient care information, comprising:
a relationships mapper component for mapping relationships between a patient, a role, and one or more teams containing the role, wherein each of the one or more teams comprising a plurality of roles and wherein each of the plurality of roles can be fulfilled by a healthcare provider; and
a patient data manager component for maintaining patient care information for the patient, wherein the patient care information includes information provided by a healthcare provider fulfilling the role in one of the one or more teams that the patient is associated with.

12. The software system of claim 11, wherein the information provided by the healthcare provider includes non-medical record comments.

13. The software system of claim 11, wherein information provided by the healthcare provider includes rounding and sign-out information.

14. The software system of claim 11, wherein information provided by the healthcare provider is shared only within the team.

15. The software system of claim 11, wherein information provided by the healthcare provider is shared with the one or more teams that the patient is associated with.

16. The software system of claim 11, further comprising a patient census manager for creating and maintaining a patient record for the patient, wherein the patient record includes the patient care information for the patient.

17. The software system of claim 11, further comprising a user interface component that allows the healthcare provider to view and modify the patient care information for the patient.

18. The software system of claim 11, further comprising a report formatter component for generating a report including the patient care information for the patient.

19. The software system of claim 18, wherein the report formatter component generates the report in different formats.

20. The software system of claim 11, further comprising a list generator component for generating a list of patients associated with the team.

21. A computing system for role-based management of patient care information for a plurality of patients, comprising a server associated with a server database for storing the patient care information for the plurality of patients, wherein the server contains a role-based patient care information management program that, upon execution, is capable of:
associating at least one (“team list”) of the plurality of patients to a team comprising a plurality of roles, wherein a role can be fulfilled by a healthcare provider;
associating at least one (“role list”) of the plurality of patients to a role;
identifying the team list associated with the team, upon receiving information specifying the team; and
identifying one or more patients (“patient list”) in the team list who are associated with one of the plurality of roles in the team, upon receiving information identifying the role in the team.

22. The computing system of claim 21, wherein the role-based patient care information management program, upon execution, is further capable of:
associating with the team any non-medical record comments provided by the team for the at least one of the plurality of patients in the team list.

23. The computing system of claim 21, wherein the role-based patient care information management program, upon execution, is further capable of:
adding a patient to the patient list, upon receiving a request; and
mapping the patient with the team and the role in the team.

24. The computing system of claim 21, wherein the role-based patient care information management program, upon execution, is further capable of:
removing one of the one or more patients from the patient list, upon receiving a request; and
disassociating the patient from the team and the role in the team.

25. The computing system of claim 24, wherein the role-based patient care information management program, upon execution, is further capable of:
archiving patient care information for the patient, wherein the archived patient care information is retrieved if the patient is later restored to the team list.

26. The computing system of claim 21, wherein the role-based patient care information management program, upon execution, is further capable of:
displaying patient care information for one of the one or more patients in the patient list.

27. The computing system of claim 21, wherein the role-based patient care information management program, upon execution, is further capable of:
updating patient care information for one of the one or more patients in the patient list according to input from a healthcare provider fulfilling the role in the team.

28. The computing system of claim 27, wherein the patient care information for the patient includes non-medical record comments provided by the healthcare provider.

29. The computing system of claim 21, wherein the role-based patient care information management program, upon execution, is further capable of:
producing a report for the patient list, upon receiving a request.

30. The computing system of claim 21, wherein the role-based patient care information management program, upon execution, is further capable of:
producing a report for one of the one or more patients in the patient list, upon receiving a request.

31. The computing system of claim 21, further comprising an output device, to which the report is sent.

32. The computing system of claim 21, further comprising at least one client device that is capable of remotely operating the role-based patient care information management program.

33. The computing system of claim 21, wherein the server database includes:
a first database storing patient care information for the patient that is generated by the healthcare provider fulfilling the role in the team that the patient is associated with; and
a second database storing patient care information for the patent that is imported from an external data source.
